(19) United States
(12) Patent Application Publication
(10) Pub. No.: US 2010/0268607 A1
(43) Pub. Date: Oct. 21, 2010

(54) System and method for direct marketing using electronic messaging to individuals within an interrogation zone

(76) Inventors: Lorena Virginia Rodriguez, Key Biscayne, FL (US); Martin Carlos Larretape, Key Biscayne, FL (US); Hernan Pablo Madera, Buenos Aires (AR)

Correspondence Address: MALLOY & MALLOY, P.A., 2800 S.W. Third Avenue, Historic Coral Way, Miami, FL, 33129, US

(21) Appl. No.: 12/386,589

(22) Filed: Apr. 21, 2009

(51) Int. Cl. G06Q 30/00; H04Q 5/22

(52) U.S. Cl. 705/14.58; 340/10.1

(57) ABSTRACT

A system and method of direct marketing to individual(s) within an interrogation zone by the presentation of customize or personalize messages to the individual selected. A plurality of tags each associated with at least one individual include response capabilities which are monitored by a reader and/or associated processor facility capable of generating interrogation signaling into the interrogation zone for purposes of activating any of the plurality of tags present therein. Upon activation, each of the plurality of tags generates and transmits identification data back to the reader or processor facility, which includes an individual identifier corresponding to the individual associated with the tag. The individual identifier facilitates access to classification data of a corresponding individual, collectively stored on the processor facility or individually stored on each of the tags, wherein the classification data enables the processor facility to determine a hierarchy or selection order of the monitored individuals present within the interrogation zone and as a result the individual to which the marketing message will be directed.

### BACKGROUND OF THE INVENTION

1. Field of the Invention

This invention relates to a system and method of marketing by directing customized and/or personalized electronic or other appropriate presentations, containing customer and/or purchasing advantages, to at least one of a plurality of individuals located within a predetermined interrogation zone and being in the possession of an RFID tag. The tags are activated causing the transmission of identification data, identifying the individuals in possession of the tags, to a tag reader and/or processor facility. The selection of individual(s) to which the marketing presentation is made may be based on purchasing history and other factors included within a customer/individual's profile, which are determinative of a selection order of the plurality of individuals being monitored.

2. Description of the Related Art

Advertising and marketing is conducted on a substantially continuous basis in all industrialized countries throughout the world. As such, attempts are made to render an advertising or marketing message more efficient, by directing an advertising campaign to a group of customers, which would be most interested in a particular product or service.

While most advertising is done on a widely exposed media basis, attempts have been made to more efficiently determine smaller groupings of potential customers which may be more receptive to specific marketing messages. Frequently, the segregation of the market, in terms of customers' interest, is often based on a customer's history which in turn may be indicative of goods or services a customer or group of customers may be most interested. Of course, a customer's history may include other factors including purchasing history as well as demographics including age, gender, economic level, geographical location etc.

Known or conventional attempts to define smaller segments or groupings of potential customers recognize the advantages, in terms of efficiency in utilizing and planning an advertising budget. As a result, it is understood that the cost of advertising would be reduced or at least more efficiently utilized, based on the ability to structure or design the content of the presented advertising to accommodate a specific segment of society which is more interested in the product or service being advertised.

Some of the conventional or known systems and methods of identifying specific groupings of individuals, for a variety of purposes, involve the use of wireless communication conducted between a control or operating entity and a plurality of individuals by utilizing radio frequency identification (RFID) tags. The broad concept of establishing bi-directional communication, of the type generally set forth above, has been utilized with at least minimal success in many areas of commerce. Depending on the field of use, disadvantages and problems in systems and methods of this type have been recognized which frequently render them insufficiently effective to justify cost of operation, set up, etc.

Therefore, there is a specific need in the advertising and marketing industry for a system and attendant method of providing direct marketing messages, which may be customized or personalized to a specific individual. In order to increase the desirability of having the direct marketing message presented to a specific individual it may contain various sale offers, reduced pricing, or other benefits which would not be immediately available to other individuals or customers viewing the direct marketing presentation. Therefore, an improved and proposed system and method for providing direct marketing messages to selected individuals, giving such selected individuals a “customer advantage”, would overcome many of the disadvantages and problems associated with known or conventional marketing techniques of the type generally set forth above.

Further, such a proposed system and method would have the ability to provide a selection order or hierarchy among the individuals being monitored throughout a predetermined interrogation zone. Such a selection order would be at least partially based on an individual's history and may involve an individual's purchasing history or pattern, frequency of visiting a given outlet, gender, economic level, etc. Further, such a proposed system would be capable of implementing the aforementioned selection order or hierarchy based on the most current and therefore relevant customer history by allowing such information to be continuously or periodically modified or “updated”. Further, the specificity of such updated information could include the most recent customer activity with regard to a specific outlet sponsoring or operating the direct marketing messaging.

### SUMMARY OF THE INVENTION

The present invention comprises a system and method for directing advertising or marketing to individuals within a predetermined interrogation zone, through the presentation of customized or personalized messages, which are preferably electronically displayed and observable by substantially all of a larger number of individuals within the interrogation zone.

More specifically, the present invention utilizes a wireless communication technique incorporating a plurality of tags, preferably radio frequency identification (RFID) tags, having bi-directional communication capabilities. In addition, at least one preferred embodiment of the system and method of the present invention includes the RFID tags, which would be in the possession of potential customers, and a centrally located reader or processor facility structured to communicate with the tags, wherein the tags and reader, etc. are operative within an ultra high frequency (UHF) range. As a result, the interrogation zone in which a plurality of individuals or customers in possession of the tags may be disposed may be significantly enlarged. The interrogation zone may include large areas within a mall or other retail, wholesale or distribution environment and may be associated with a kiosk or other facility for containment of the reader and/or a display facility for presenting the marketing messages. Accordingly, the system and method of the present invention facilitates “customer tracking” and/or “customer visibility” in terms of allowing a participating store or outlet operator to be aware of shopping, purchasing, browsing habits, etc. of the tagged customer/individual. In more common terms, the store or outlet operators are allowed to “see” what the customers do and where they go while shopping.

By way of example, each of the plurality of tags associated with the system and method of the present invention are preferably incorporated in some type of card or like device easily and typically carried on the person of the individuals. Such cards may include credit cards, reward cards or a variety of other types of devices of sufficient dimension and structure to be easily carried and accessed. However, other devices or techniques may be used to facilitate possession of the tags by the individuals or customers, which assures there presence and detection when in the interrogation zone.

The aforementioned tag reader and/or processor facility includes an RF transmitter having bi-directional communication capabilities so as to freely and wirelessly communicate with the RFID tags incorporated within the cards or other devices within the possession of the individual. Further, the reader, which may be directly associated with the processor facility, includes monitoring capabilities which may be more specifically defined as the ability to generate interrogation signals at least throughout the interrogation zone. Such interrogation signaling may be done on a continuously streaming basis or periodically for purposes of determining the existence of any associated RFID tags present within the interrogation zone. The interrogation signals are more specifically structured to activate the RFID tags, which in turn results in the transmission or generation from the tags to the reader/processor facilities of identification data. The identification data is generated in response to being activated by the interrogation signals and more specifically includes sufficiently adequate data to recognize or identify the individual(s) possessing the tag, at least to the extent of facilitating the classification or ranking the individual into a selection order or hierarchy of individuals also present within the interrogation zone.

More specifically, the identification data embedded within the response signal generated by the monitored tag(s) include an individual identifier and/or sufficient classification data to provide the reader or processor facility with sufficient information to identify the individual in terms of personal identification as well as individual history in terms of customer activity. Accordingly, as used herein the term “classification data” is substantially the equivalent of a customer/individual's customer profile or profile data. Based on individual's history or profile data, including customer activity or information, a hierarchy of the monitored individuals carrying the RFID tags is established and a selection is made of the highest ranking individual.

Thereafter a direct marketing presentation or marketing message may be displayed on an appropriate display assembly observable throughout at least a portion or substantially the entirety of the interrogation zone. Such a direct marketing presentation may be customized or personalized to the extent that the selected, highest ranked, individual clearly understands that the direct marketing presentation or message is directed to him or her. Accordingly, the personalized message may include an individual's name or other clearly recognizable content that informs the selected individual that the message is directed to him/her.

Further, the content of the direct marketing message will provide the selected, “highest ranking” individual with a customer advantage in terms of lower sales price, availability of new products or services or other “bargains” which may not be currently available to other individuals or customers even though they may be located in the interrogation zone and be in the possession of the associated RFID tags. Therefore it should be apparent that a “spirit of competition” may soon develop by tagged individuals that frequent the interrogation zone. More specifically, upon recognition by non-selected individuals, that the selected individual receives significant benefits in terms of purchasing advantages of various products or services, the non-selected individuals may take specific steps to increase their chances of being selected.

By way of example, individuals may visit and/or make purchases from an outlet on a more frequent basis. Alternatively and or in addition, individuals may frequent an outlet associated with the interrogation zone during “off-hours” when there is normally fewer customers present. All of these activities may “improve” an individual's history thereby raising their hierarchy and selection order and result in a better chance of being selected. It should be equally apparent that an increase in the activities by customers, of the type set forth above, may also result in significant benefits to the outlet associated with the interrogation zone, in terms of increased sales, customer traffic, etc.

Other features associated with the system and method of the present invention include the plurality of tags being more specifically structured to include enhanced storage capabilities which contain the history of a corresponding individual contained therein in addition to the individual identifier. As such, the classification data generated by the monitored tags, in response to receiving the interrogation signal, may serve to initially identify and thereby facilitate recognition of an individual such as through aforementioned individual identifier. In addition the enhanced storage capabilities may allow for the subsequent or concurrent transmission of the aforementioned individual history.

Moreover, in this preferred embodiment of the present invention the storage capabilities associated with the plurality of tags may also include an update application, which allows for the most current customer or individual activity to be included within the individual history stored within the corresponding RFID tag. Such an update application may be specifically structured to interact with security monitors, cash registers or other purchasing facilities. As such, the update application may be receptive to wireless or direct contact communication, such as when a credit card or reward card in which the tag is embedded is processed to accomplish a purchase or other related activity associated with a customer/individual's presence or activity regarding one or more products or services.

Alternatively, the individual's history may be stored in a database associated with the aforementioned processor facility and/or reader assembly. In this embodiment the receipt of the individual identifier or other portion of the identification data by the reader will trigger access to the database associated with the processor facility which may be remote from the interrogation zone or be considered an associated part of the reader assembly. Such database access to the individual's history will allow for the determination of the hierarchy of individuals being monitored within the interrogation zone and thereby establish the selection order of individuals carrying tags and concurrently present within the interrogation zone. In this embodiment, the update application may also be operative as part of the processor facility, wherein the current customer activity of an individual will be communicated from a corresponding cash register, security monitor or other customer recognition facility to the processor facility for immediate update of an individual's history.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of at least one preferred embodiment of the system of the present invention.

FIG. 2 is a schematic representation of an RFID tag associated with the system and method of the present invention.

FIG. 3 is a schematic representation of a processor facility operatively associated with other components of the system and method of the present invention.

FIG. 4 is a schematic representation in block diagram form representing at least one embodiment of the method of the present invention.

FIG. 5 is a schematic representation in block diagram form which may be associated with the embodiment of FIG. 4 and represent yet another preferred embodiment of the present invention.

FIG. 6 is a schematic representation in block diagram form of another embodiment of the present invention which may be associated with the embodiment of FIG. 4.

Like reference numerals refer to like parts throughout the several views of the drawings.

### DETAILED DESCRIPTION OF THE PREFERRED EMBODIMENT

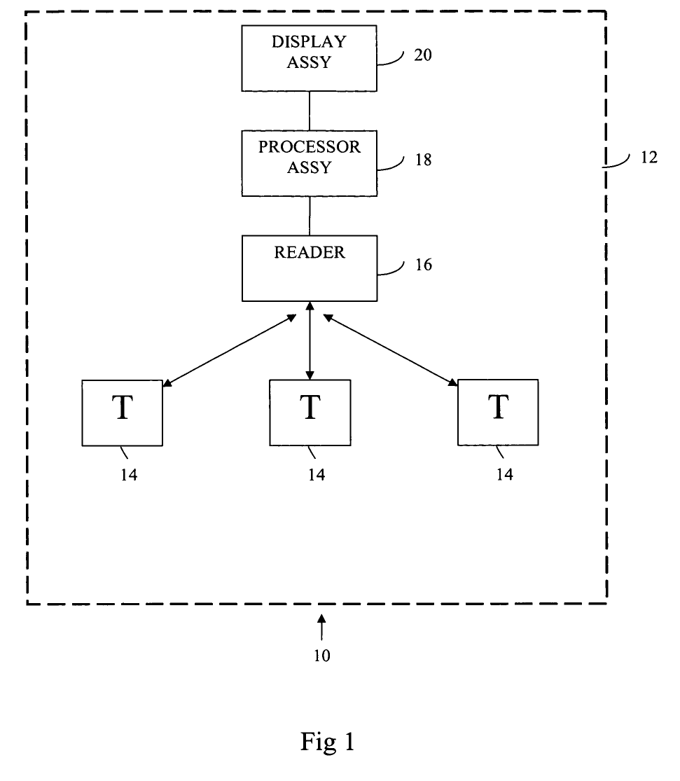

As represented in the accompanying Figures, the system of the present invention is generally indicated as 10 and includes a plurality of components schematically represented in their various embodiments in FIGS. 1 through 3. More specifically, the present invention is directed to a system and method for presenting marketing presentations or displays, which are preferably electronically generated, to selected individuals present within an interrogation zone, generally indicated as 12, each of which are in the possession of a tag, more specifically a radio frequency identification (RFID) tag 14.

As also represented in FIG. 1, a monitoring reader generally indicated as 16 is located within or otherwise operatively associated with the interrogation zone 12. The reader 16, and the plurality of tags 14 in the possession of different individuals present within the interrogation zone 12, are collectively capable of establishing a bi-directional communication therebetween. Further, in at least one preferred embodiment the bi-directional communication of the plurality of tags 14 and the reader 16 is operative within an ultra high frequency (UHF) range. This extended operative range enables the sizing of the interrogation zone to be significantly increased so as to be extended throughout relatively large areas in retail, wholesale or distribution environments. As such, the interrogation zone 12 may include part of a shopping mall or a variety of other public areas, where a plurality of individuals and/or potential customers may gather for purposes of shopping, product or service review, etc.

In addition, a processor facility 18 is disposed in operative communication with the reader 16. In at least one preferred embodiment the processor facility 18 may be directly associated therewith such as being commonly disposed and/or cooperatively structured. Alternatively, the processor facility 18 may be located remote from the reader 16 and from the interrogation zone 12 but still be connected, either through wireless or hard wire connections, to the reader 16 as well as a display facility or assembly 20. As will be explained in greater detail hereinafter, the display assembly 20 is capable of presenting video, audio or a combination thereof to the interrogation zone 12 and may include one or more display screens or like communicating display devices. As such, the display assembly 20 will be disposed and structured to enable substantially all of the individuals in the possession of the tags 14 to view or be exposed to the display assembly 20. As such, when a predetermined, customized and/or personalized marketing presentation is presented on the display assembly 20, it should be observable by substantially all of the individuals in possession of the tags 14 located within the interrogation zone 12.

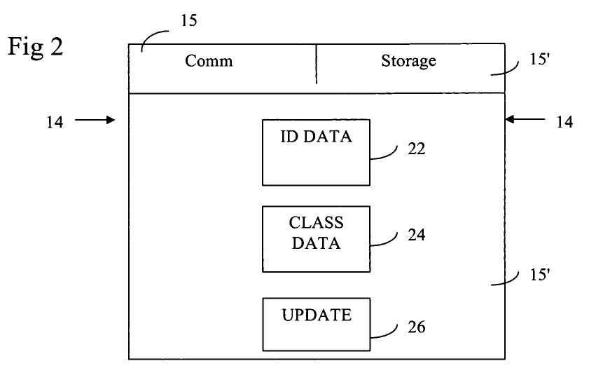

With primary reference to FIG. 2 as applied to the system of the embodiment of FIG. 1, each of the plurality of RFID tags 14 include the aforementioned communication capabilities 15 which is operable within a UHF band and which is further capable of bi-directional communication with the reader 16 and in certain applications, with the processor 18. Further, the plurality of RFID tags 14 may also include enhanced or appropriate storage facilities as 15′ which cooperate with the communication facilities 15 of each of the tags 14 so as to facilitate data being communicated, in a manner set forth in greater detailed hereinafter, with the reader 16 and/or the processor 18. More specifically, the storage facilities 15′ of the plurality of tags 14 may include the storage of identification data as at 22 and, in certain preferred embodiments, the additional storage of classification data 24. Further, an update application 26 may be directly associated with the classification data 24 so as to maintain a current history of an individual specifically relating to a customer/individual's most frequent purchasing activities. Such purchasing activities cam include purchases and/or visitations associated with a specific outlet or outlets associated with and/or sponsoring the interrogation zone 12, and/or the monitoring procedures conducted therein.

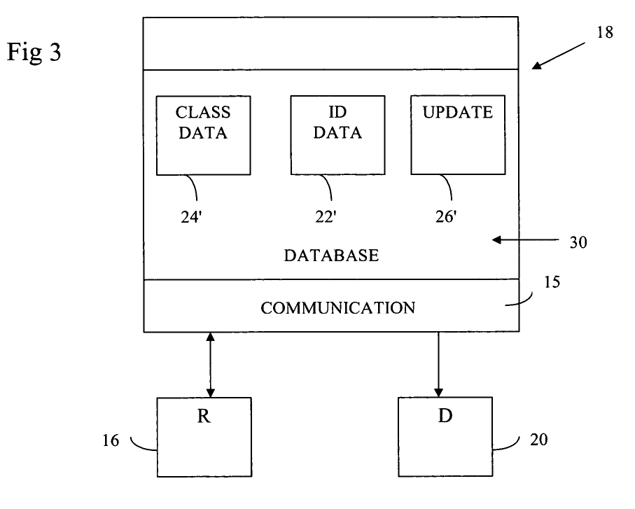

The embodiment of FIG. 3 primarily applies to the system 10 of the embodiment of the embodiment of FIG. 1. Accordingly, the processor 18 also includes a data base 30 having sufficient appropriate storage facilities to store a plurality of customized messages, the content of which are delivered by the display assembly 20 to the plurality of individuals within the interrogation zone 12. As will be more apparent hereinafter, the content of the displayed message or presentation may be dependent, at least in part, on the selected individual to which the marketing message is directed. As also noted, the chosen message may be modified subsequent to selection to personalize the advertising content of the message at least to the extent of including a selected individual's name or other identifying characteristics which render the direct marketing message presented on the display assembly 20 recognizable by the selected individual.

The content of the message, as preferably electronically displayed, can also be directive and/or instructive at least to the extent of directing the selected customer/individual to a customer interactive location. By way of example, the customer may be directed to a kiosk or other readily accessible location or area which may include appropriate customer interface facilities such as, but not limited to, a keyboard, touch screen mouse or any other of a variety of customer input devices which allow the customer access to a coupon or other object representative of the awarded benefit he/she is to receive. As such the award may be printed on the coupon, etc or at least partially “hidden”, such as being encrypted in bar code or similar indicia.

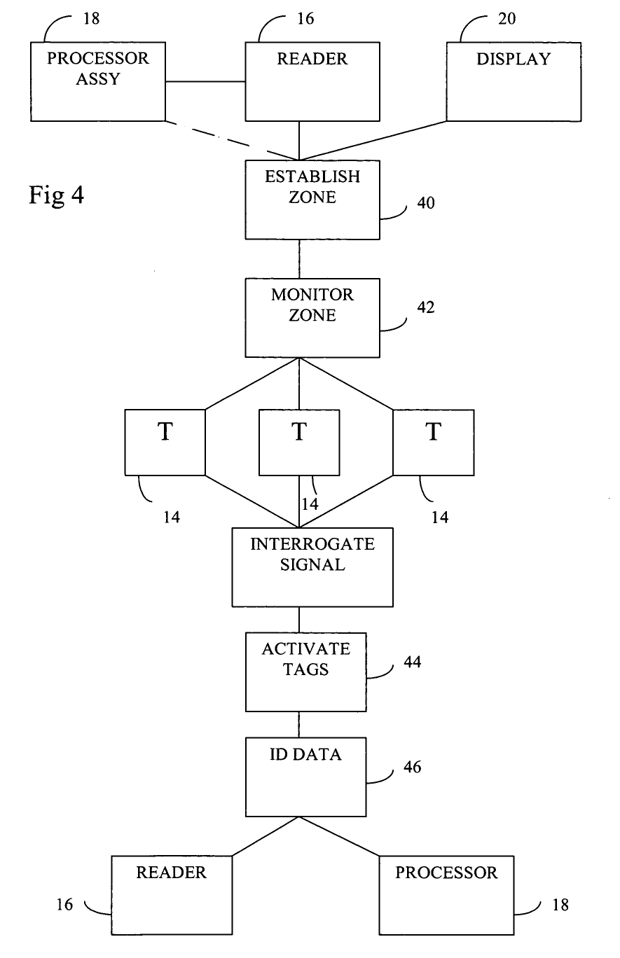

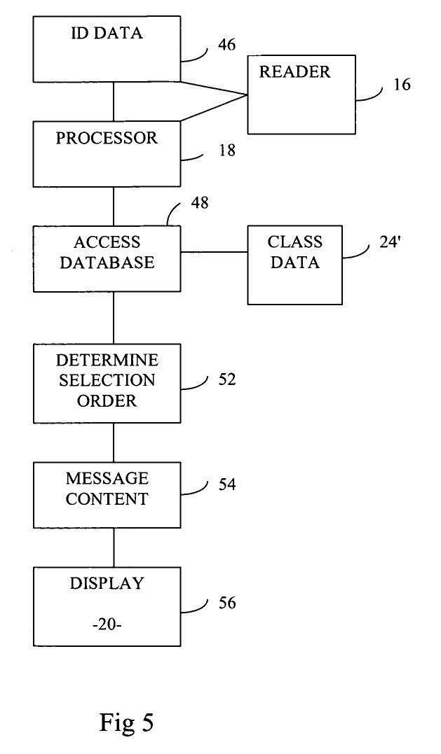

As will be explained in detail with regard to the method 100, as represented in FIGS. 4 and 5 as well as FIG. 3, the database 30 of the processor may also include a collection of classification data 24′ representing the histories of all the individuals in the possession of the RFID tags. This is distinguishable from the embodiment of FIG. 2, wherein the classification data 24 of a single individual corresponding to that individual in possession of the tag 14 will be stored and maintained for eventual communication to the reader 16 and/or the processor 18. Accordingly, the classification data 24′ stored in the processor 18 will be a collection of all of the individuals in possession of the various RFID tags 14, wherein such histories may be pre-registered, stored and updated as required. In contrast, the classification data 24 stored in the enhanced storage capabilities of the RFID tag 14 only represents the history of the individual in possession of the tag 14, or other authorized user/individual such as a family member.

In either case each individual's history may include a variety of characteristics such as, but not limited to purchasing history, visitation frequency, purchasing patterns age, gender, economic level, geographical location, etc. Individual ones of the factors of an individual's history or a combination of such factors are used to establish a selection order or hierarchy of individuals concurrently within the interrogation zone 12 at a given time. The selection order will be based on aforementioned hierarchy to the extent that the individual having the “best” or most appropriate history, based on the aforementioned factors, will be chosen as the selected individual to receive the direct marketing message or presentation observable on the display assembly 20 from preferably all parts of the interrogation zone 12.

With reference to FIG. 4, the method of operation and application associated with the system 10 is generally indicated as 100. Method 100 includes the communication of the reader 16, and in certain preferred embodiments the processor 20, being operatively associated and in bi-directional communication with the tags 14 present in the interrogation zone 12. Such bi-directional communication is established once the boundaries or dimensioning of the interrogation zone 12 is established as at 40. As set forth above, the plurality of RFID tags 14 and the reader 16 and possibly the communication capabilities associated with the processor 20, may operate on a UHF band. As such, the sizing of the interrogation zone 12 may be significantly enhanced while still maintaining reliable communication between the various components of the system 10, as set forth in greater detail hereinafter.

The method 100 further includes the continuous or periodic monitoring 42 of the interrogation zone using the aforementioned bi-directional communication between the RFID tags, reader 16 and possibly the processor 20. The monitoring 42 of the interrogation zone 12 comprises a periodic or continuously streaming interrogation signaling directed to any of a plurality of tags 14 currently located within the interrogation zone 12. When an interrogation signal 43 is received by the plurality of tags 14, the tags 14 are activated, as at 44, and thereafter perform the generation and transmission of identification data 46 back to the reader 16 and/or directly to the processor 18. The transmission of the identification data 46 more specifically includes the transmission of an individual identifier which corresponds to and/or facilitates the identity of the individual in possession of each of the plurality of tags 14. This individual identifier is, as set forth above, communicated directly to the reader and in turn transferred to the processor 18. Alternatively, the communication capabilities of the system 10, being bi-directional and within the UHF operational band, may accomplish transmission of the individual identifier directly to the processor 18.

Accordingly, at least one preferred embodiment of the present invention, as represented in FIG. 5, comprises the identifying signal transmitted either to the reader 16 or directly to the processor 18. In either case, the individual identifier will serve to access the database 30, as at 48, wherein further access to the collection of classification data as at 24′ is accomplished. The individual identifier will serve to locate the corresponding individual history which will be reviewed to determine a hierarchy and eventual selection order as at 52, of the individuals present within the interrogation zone during a given monitoring period thereof. More specifically, the selection order is based on a hierarchy of the individual's history and more specifically relates to the individual having the “best” or most appropriate purchasing history, customer activity, or other factors or combination of factors which render one of the monitored individuals the best choice to be selected for receipt of the marketing presentation as presented by the display assembly 20. Therefore, once the individual history of the plurality of individuals located within the interrogation zone 12 has been chosen, the individual being selected will have a customized and/or personalized presentation directed to the selected individual throughout the interrogation zone 12 as at 56. The content of the customized direct marketing message may include various customer advantages such as reduced prices, products not previously available or other “bargains” not currently presented to other individuals located within the interrogation zone 12. Also, the message content observable on the display assembly 20, as at 56, will be sufficiently personalized to allow the selected individual to recognize himself or herself, so as to take advantage of the “bargains” evidenced by the content of the direct marketing message appearing on the display 20, as at 56.

As set forth above, the content of the message can also be informational and/or instructive at least to the extent of directing the selected customer/individual to a customer interactive location. By way of example, the customer may be directed to a kiosk or other readily accessible location or area which may include appropriate customer interface facilities such as any one or more of a variety of customer input devices which facilitate access to a coupon or other object representative of the awarded benefit or “bargain” the customer is to receive. As such the award or bargain may be printed or otherwise clearly displayed on the coupon. Alternatively, the bargain or award may be at least partially “hidden”, such as by being encrypted in bar code or similar indicia.

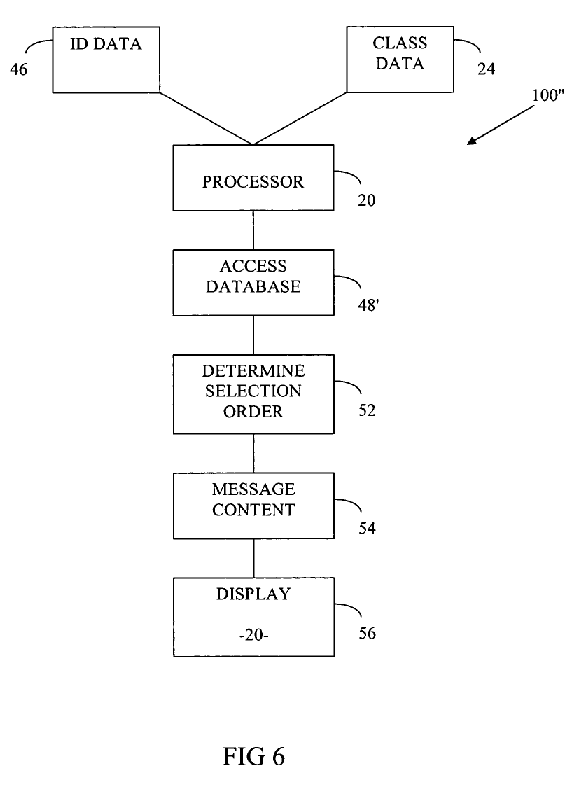

With the primary reference to FIG. 6 yet an additional embodiment of the present invention schematically represented a modification of the method, 100″. More specifically, in this embodiment the aforementioned classification data representing the individual's history and/or customer participation is stored on the corresponding tag 14 in his or her possession. As described with primary reference to FIG. 2, such individual classification data 24 is only representative of the individual which is in the possession of the RFID tag or other authorized individual. This is distinguishable from the embodiment schematically represented in FIG. 3, wherein a collection of the individual histories are stored on the processor 18, as at 24′ for all individuals in the possession of an RFID tag 14.

Further with regard to the embodiment of FIG. 6, once the tag is activated, the identification data in the form of the individual identifier 46 is transmitted to the reader 16 and/or directly to the processor 18, as at 46′. However, in addition after or concurrently to the transmission of the individual identifier 46 to the processor 18 (or the reader 16 and subsequently to the processor 18) the classification data 24 stored in the enhanced memory capability 15′ of each of the tags 14 will also be transmitted to the processor 18. Upon receipt of both the individual identifier 46 as at 46′ and the classification data 24 as at 46″, the processor will access the database associated with the processor as at 48′ for purposes of determining the selection order or hierarchy for all the individuals present within the interrogation zone 12 by a review of all the respective individual history associated therewith. The hierarchy or selection order will result in the selection of the most appropriate individual i.e., the individual having the best individual history or customer activity, as at 52.

Thereafter, similar to the embodiment of FIG. 5, the message content will be determined in terms of customizing the content for customer advantages or “bargains” and perhaps and in certain instances personalizing the message content as at 54 to assure that the selected individual will identify with the display marketing message presented on the display assembly 20 as at 56.

Each of the above noted embodiments of the present invention include the provision of an update application 26 and 26′ which allows for the most current customer or individual activity to be included with the individual history whether such individual history was stored as individual classification data 24 in each of the tags 14 or the collective individual histories 24′ stored in the processor 18. Such an update application 26 and/or 26′ will be specifically structured to interact with the various security monitors, cash registers or other purchasing or security monitoring facilities within an outlet associated with the interrogation zone 12. As such, when a credit card or reward card in which the individual RFID tag 14 are embedded are processed in terms of a purchase or other customer activity associated with a customer's presence, such activity will be updated to the extent that the classification data 24 or 24′ will be currently modified.

Other features associated with the practice of the system 10 and the method 100, 100′, 100″ of the present invention facilitate the possibility of the development of a “spirit of competition” by individuals present within the interrogation zone 12. More specifically, upon recognition by non-selected individual within the interrogation zone 12 that other individuals, having been selected, receives significant customer benefits “bargains”, the non-selected individuals may take specific steps to increase their chances of being selected. By way of example only, the non-selected individuals may visit or may purchases from the outlet or outlets associated with the interrogation zone 12 and/or may change their shopping patters so as to visit the outlet or outlets as well as the corresponding interrogation zone 12 during “off-hours” when there is normally fewer individuals or customers present. One of these activities may “improve” an individual's history thereby raising their hierarchy and selection order and most probably result in a better chance of being selected since they would be closer to the top of the selection order. Such an increase in customer or individual activities, of the type set forth above, may also result in significant benefits to the outlet or outlets associated with the interrogation zone 12.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for marketing to selected one of a predetermined plurality of individuals, said system comprising:
a) a plurality of tags each associated with a different one of the plurality of individuals, each tag including response capabilities,
b) a reader including monitoring capabilities directed to a predetermined interrogation zone,
c) said monitoring capabilities including interrogation signaling for activating said plurality of tags within said interrogation zone,
d) said response capabilities including a signaling of identification data by said plurality of tags within said interrogation zone performed in response to receipt of said interrogation signaling, and
e) said identification data facilitating access to classification data, said classification data determinative of a selection order of individuals within said interrogation zone being targeted for a direct marketing presentation.

2. A system as recited in claim 1 wherein said plurality of tags include storage capabilities for said classification data, said classification data transmitted from said tags to a processor facility.

3. A system as recited in claim 2 wherein said storage capabilities include an update application facilitating modification of said classification data.

4. A system as recited in claim 3 wherein said update application is responsive to current customer activity of the individual and corresponding modification of said selection order.

5. A system as recited in claim 1 further comprising a display facility disposed in communicating relation to said interrogation zone and the plurality of individuals therein; said display facilities operatively associated with said processor facility and structured for communication of said direct marketing presentation to the selected individual.

6. A system as recited in claim 5 wherein said direct marketing presentation comprises personalized messaging corresponding to the selected individual within said interrogation zone.

7. A system as recited in claim 1 further comprising a processor facility including a database, said database including individual histories selectively accessible by said processor facilities dependent on said identification data of corresponding tags communicated to said reader.

8. A system as recited in claim 7 wherein said identification data further includes an individual identifier communicated to said processor for access to stored individual history of corresponding to said individual identifier.

9. A system as recited in claim 8 wherein said processor facility further includes an update application, said update application is responsive to current customer activity of the individual and corresponding modification of said selection order.

10. A system as recited in claim 9 further comprising a display facility disposed in communicating relation to said interrogation zone and the individuals therein; said display facility structured for communication of said marketing presentation.

11. A system as recited in claim 10 wherein said direct marketing presentation are dependent on a selected individual's history.

12. A system as recited in claim 1 wherein said reader and said plurality of tags include bi-directional communication capabilities operational within an ultra high frequency range.

13. A system as recited in claim 1 wherein said plurality of tags comprise RFID tags.

14. A method of marketing to a selected one of a predetermined plurality of individuals present within a predetermined interrogation zone, the method comprising:
a) structuring a plurality of tags to include response capabilities and an individual identifiers each associated with a different one of the plurality of individuals within the interrogation zone,
b) monitoring the interrogation zone to determine an existence of tags within the interrogation zone,
c) including within the monitoring the generating of interrogation signals from a tag reader to tags within the interrogation zone,
d) defining the response capabilities of the plurality of tags to include communicating corresponding individual identifiers from monitored tags to the reader and operatively associating a processor facility with the tag reader,
e) determining a selection order of the monitored tags and corresponding individuals based on classification data associated with each individual and storing the classification data within the processor facility,
f) selecting an individual within the interrogation zone having the highest selection order, and
f) presenting direct marketing messages to the selected individual representative of the direct marketing content.

15. A method as recited in claim 14 including accessing the classification data within the processor facility based on receipt of and corresponding to the individual identifier.

16. A method as recited in claim 14 including bi-directional communication capabilities operative within an ultra high frequency range in the plurality of tags and the reader.

17. A method as recited in claim 16 comprising sizing the predetermined interrogation zone to accommodate a range of communication between the processor facilities and the plurality of tags corresponding to the ultra high frequency range of operability.

18. A method as recited in claim 14 comprising locating the processor facility remote from the tag reader and maintaining a communication facility there between.
